(19) United States
(12) Patent Application Publication
(10) Pub. No.: US 2019/0349481 A1
(43) Pub. Date: Nov. 14, 2019

(54) SYSTEM AND METHOD FOR TRACING A COMMUNICATIONS PATH OVER A NETWORK

(71) Applicant: Level 3 Communications, LLC, Broomfield, CO (US)

(72) Inventors: Adam C. Uzelac, Rochester, NY (US); Al-Hassan Ibrahim, Atlanta, GA (US)

(73) Assignee: Level 3 Communications, LLC, Broomfield, CO (US)

(21) Appl. No.: 16/409,504

(22) Filed: May 10, 2019

Related U.S. Application Data
(60) Provisional application No. 62/670,376, filed on May 11, 2018.

(51) Int. Cl. H04M 7/00; H04M 3/08; H04M 3/22; H04M 3/42; H04L 12/707; H04L 12/721

(52) U.S. Cl. CPC H04M 7/0084; H04M 3/085; H04M 3/2254; H04L 45/44; H04M 7/0075; H04L 45/22; H04M 3/42059

(57) ABSTRACT

A call path through one or more communications networks can be traced by retrieving voice equipment information based on a call data record (“CDR”). A path through the networks and across multiple routers may be identified based on the CDR and voice equipment information. Router operation information may be retrieved from each of the multiple routers. A filterable interface can be generated based on the CDR, voice equipment information, and router operation information through which configurations to the networks may be performed.

### CROSS-REFERENCE TO RELATED APPLICATION

This application is related to and claims priority under 35 U.S.C. § 119(e) from U.S. Patent Application No. 62/670,376, filed May 11, 2018 entitled “System and Method for Tracing a Communications Path Over a Network,” the entire contents of which is incorporated herein by reference for all purposes.

### TECHNICAL FIELD

Embodiments of the present invention generally relate to systems and methods for managing call routing over a network, and more specifically to tracing a voice communications session across a network.

### BACKGROUND

Troubleshooting a voice communications session, such as a web call or voice over Internet protocol (“VOIP”) session, may require inspecting devices along a call route, or path through a network over which the voice communications session sends data. Typically, information from each voice equipment and/or router along the call route is obtained by accessing the equipment manually. Furthermore, identifying each device may require step by step inspection of the call path in order to determine a next hop from one device to the next across the entire call route. As a result, troubleshooting the various equipment of a call route through a network can be tedious, expensive, and slow.

It is with these observations in mind, among others, that aspects of the present disclosure were concerned and developed.

### SUMMARY

In a first embodiment of the invention, a method for tracing a path of a voice communication transmission over a network includes receiving a first call detail record (“CDR”) from a first voice equipment, the first voice equipment issuing a voice communication transmission to a network, receiving voice equipment operating information from the first voice equipment, receiving first router operating information from a first router, the first router indicated by the first CDR, and generating an interface including the first voice equipment operating information and the first router operating information.

In another embodiment, the method further includes receiving a next hop information from the first router, and receiving second router operating information from a second router based on the next hop information from the first router, wherein the interface further includes the next hop information and the second router operating information.

In another embodiment, wherein the second router is associated with a second voice equipment, the method further includes receiving, from the second voice equipment a second CDR and a second voice equipment operating information, wherein the interface further includes the second voice equipment information.

In another embodiment, the method further includes receiving multiple router information from respective multiple routers, the multiple routers being hops between the first router and the second router within the network, wherein the interface further includes the multiple router information.

In another embodiment, the network includes one or more of a client network, an Internet service provider (“ISP”) network, or a voice network.

In another embodiment, the first voice equipment is identified based on a database storing call information associated with voice equipment identifiers.

In another embodiment, the method further includes receiving a filter selection for one of particular information or particular devices, wherein the interface includes information based on the received filter selection.

### BRIEF DESCRIPTION OF THE DRAWINGS

FIG. 1 is a schematic diagram illustrating an exemplary voice communications session over multiple networks, in accordance with various embodiments of the present technology;

FIG. 2 illustrates a reporting interface for a call trace path, in accordance with various embodiments of the present technology;

FIG. 3 is a system diagram of an application for tracing a call path over a network, in accordance with various embodiments of the present technology;

FIG. 4 is a flowchart illustrating a method for tracing a call path over a network, in accordance with various embodiments of the present technology;

FIG. 5 is a flowchart illustrating a method for tracing a call path through a virtual private network, in accordance with various embodiments of the present technology; and

FIG. 6 is a diagram illustrating an example of a computing system which may be used in implementing various embodiments of the present disclosure.

### DETAILED DESCRIPTION

Aspects of the present disclosure involve systems, methods, computer program products, and the like, for tracing a path of a voice communication session between each terminal of the session. A path may include many devices, beginning with, for example, a computer terminal that initiates a call and being routed by routers within various networks and connected to voice equipment for managing a call transmission to another computer terminal receiving the call. In general, the process allows for all or some subset of devices used in the call path to be identified. More particularly, a user interface can be automatically generated and may enable a user of the interface to retrieve performance information from each identified device along the call path.

Manually tracing a voice communication path through a network can be a tedious and slow process. Oftentimes, a technician must have significant understanding of one or more network infrastructures in order to correctly execute the sequence of commands necessary for proper tracing. In particular, it can be exceedingly difficult to manually trace a voice communication path in real time or even within a short time window following a session. An automated process for tracing a voice communication path and for rendering the result of the trace may provide an input into a downstream service (e.g., via user interface, application programming interface (API), microservice integration, etc.) that can identify and/or correct issues with devices along the path, as well as provide information from which a technician may diagnose and rectify network errors.

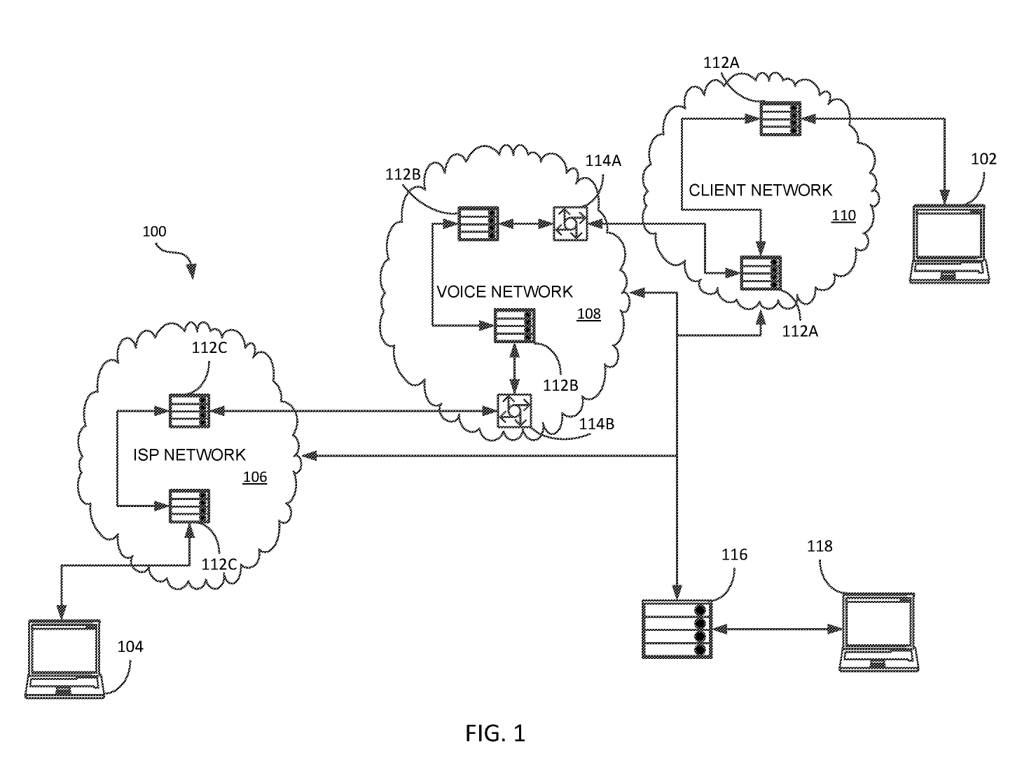

FIG. 1 illustrates an exemplary network environment 100 for a call or other voice communications session. The call may take place between an initiating terminal 102 and a responding terminal 104. As depicted here, the terminals 102 and 104 are laptop computers. However, any voice communication terminals may participate in a voice communication session across operating environment 100. For example, either or both of terminal 102 and 104 may be, in some examples and without imputing limitation, a voice over Internet Protocol (VoIP) device, a cell phone, a desktop computer, a tablet computer, and other devices capable of performing voice communication sessions over a network.

Terminal 102 can initiate a voice communication session, for example, through a software application such as Level 3® Wholesale Voice Services, Microsoft® Skype®, and the like. The communications may be routed through a network 110 and via routers 112A on the network 110. The network 110 may be any type of communications network, including but not limited to, a client network, a private network, a university network, a virtual network, and the like, and may also include the Internet,. Moreover, a call may traverse different networks (such as voice network 108 and Internet Service Provider (ISP) network 106) and, in some examples, call paths may be directional. In other words, transmissions from terminal 102 to terminal 104 may follow a different path across the various networks (in some cases, including different networks altogether) than transmissions within the same call from terminal 104 to terminal 102.

The voice communication session may exit the client network 110 and enter into a voice network 108 or other type of communications network. The voice network 108 may include routers 112B that operate similarly to the client network 112A routers discussed above. Further, the voice network 108 can include voice devices 114A-B (e.g., provider edge devices, media gateways, etc.) for managing voice transmissions. The voice devices 114A-B may each peer with an in-network router 112B as well as a router 112A or 112C located outside the voice network 108 in a neighboring or connected network.

An ISP network 106 or other type of network may receive a communications session from the voice network 108 in order to pass the session along to the responding terminal 104. As above, the ISP network 106 can include multiple ISP network routers 112C for managing communications traversing the network.

Further, as depicted by FIG. 1, a computing device 118 can be used to trace a path of the voice communication session throughout the various devices and networks of the network environment 100. The device 118 can retrieve the path of the session through one or more servers 116 running a software application performing methods and processes as discussed herein. In some examples, the device 118 may render the path provided to it by the server 116 via a user interface. In other examples, the computing device 118 may run the software application and directly perform the methods and processes discussed herein.

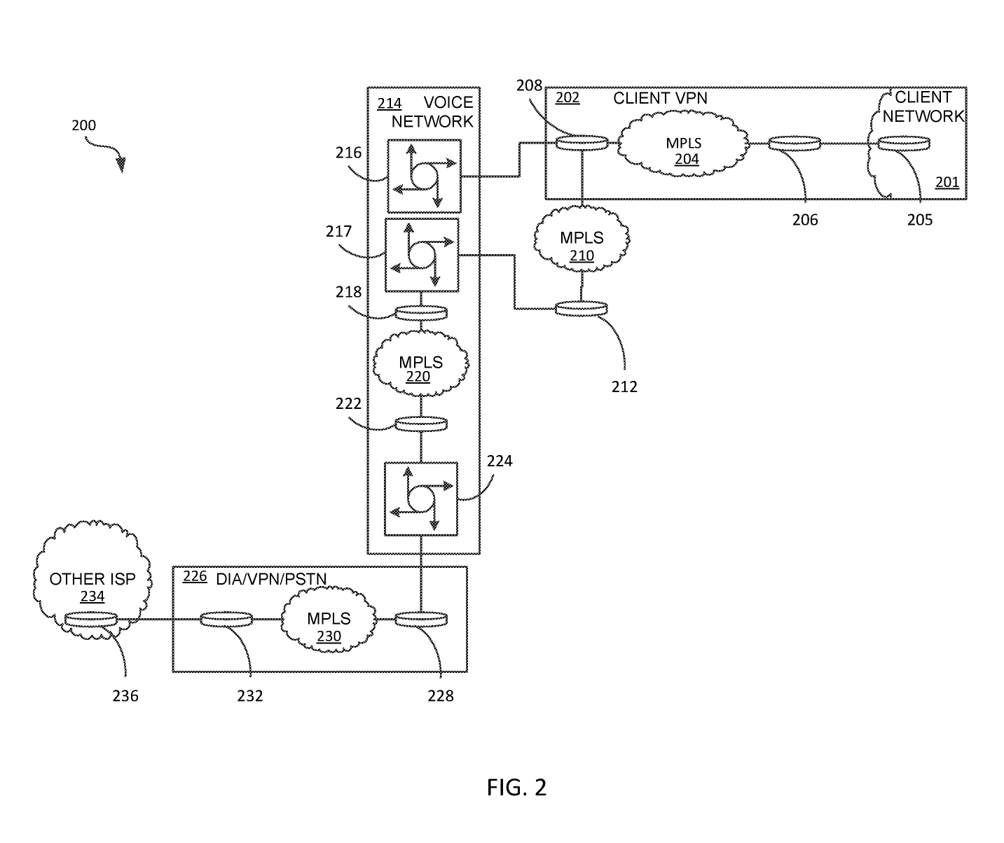

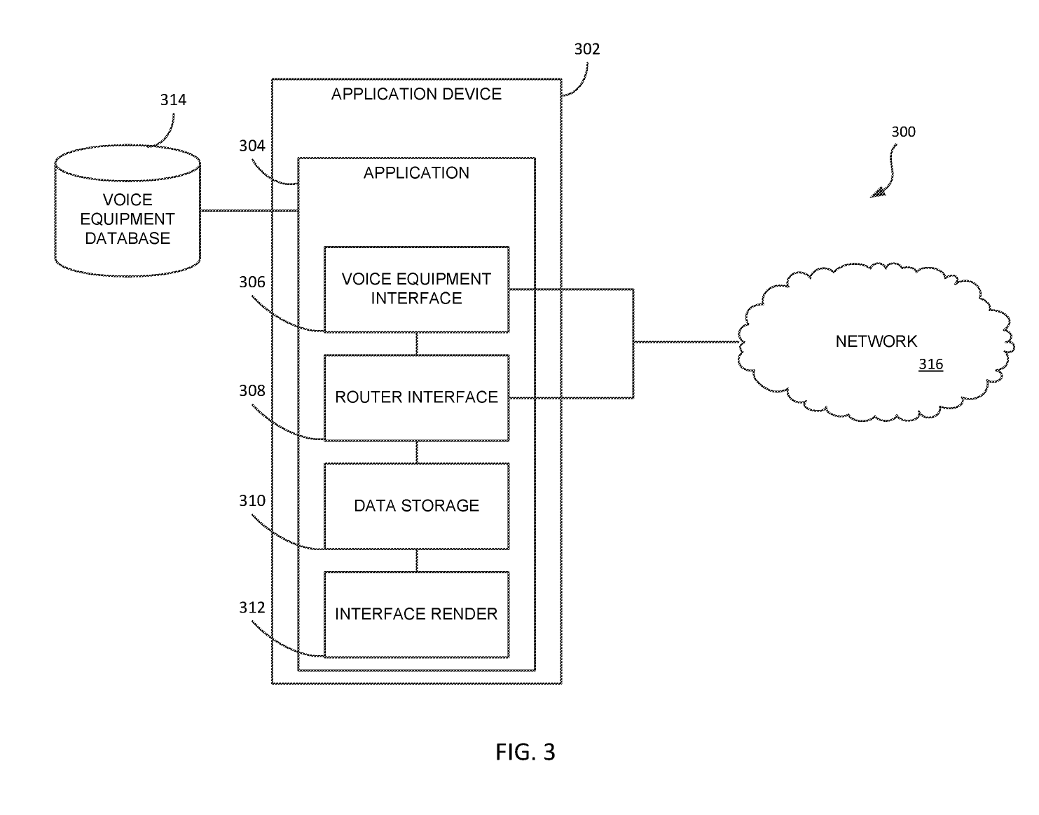

FIG. 2 and FIG. 3 depict a user interface 200 and a system 300 that can generate the user interface 200, respectively. The user interface 200 may be generated as the system 300, and software application 304 in particular, traces a path of a voice communication session across network environment 100. In some examples, the user interface 200 can be generated dynamically in real-time as a voice communication session is taking place. The software application 304 can include an interface rendered 312 which generates the user interface 200 to provide a representation of a voice communication session, or call, path through one or more networks. In other words, elements of the user interface 200 map to actual network components and relationships between those network components, as identified by the system 300 (and rendered for displayed by the interface rendered 312).

The user interface 200 can be generated after or while a session has completed by the system 300 accessing a call detail record (“CDR”) on a voice device, retrieving origination and destination information from the CDR, identifying a peering router connected to the voice device, and traversing across one or more networks from the peering router and to either or both the call origination point or the call destination point. A routing table, or forwarding table, may be stored on the peering router and used to identify a next point (e.g., another router receiving traffic from the peering router) along the call path through the network environment 100, which may in turn hold another routing table which can be used to identify another point along the call path, and so on.

A CDR may be stored on, or otherwise associated with, voice equipment such as voice devices 114A-B, for routing and processing voice communication sessions and may be located within a network 316 (e.g., voice network 108). The CDR can contain, among other information, a device of origin identification, a call (e.g., a voice communication session) identification, a source Internet Protocol (“IP”) address, a destination IP address, and the like. An application device 302 (e.g., server 116) can execute a software application 304 in order to trace a call or other voice communication session, and generate the user interface 200. The application device 302 may access the network 316 via any network access mechanism (e.g., direct link, landline, cable connection, wireless, mobile network, and the like) and connect to specified routers and voice equipment deployed within the network 316.

The software application 304 may receive a call identification and/or call origination or destination information, which can be used to query a voice equipment database 314 for identification of voice equipment containing an appropriate CDR. For example, individual origination values (e.g., a dialing phone number) may be associated, within the voice equipment database 314, with particular voice devices 114A-B. The software application 304 can interact with the identified voice equipment using a voice equipment interface 306. The voice equipment interface 306 can include protocols and rules for interfacing with a variety of different voice equipment and may select an appropriate protocol or rule based on the voice device identified by the voice equipment database 314. In some examples, the appropriate protocol or rule may be stored in the voice equipment database 314 and passed back to the software application 304 along with an identification of the voice device of the network 316 having an appropriate CDR for processing.

The voice equipment interface 306 can also retrieve identification of peering routers linked to a particular voice device. Each voice device may be connected with one or more peered routers as depicted in FIG. 1 and discussed above. For example, a voice device 114A of voice network 108 may be linked to a peering router 112A in the client network 110. Similarly, other linked routers, such as voice network router 112B, can be identified by the voice equipment interface 306. The voice equipment interface 306 may identify the routers by an IP address associated with the routers, which may then be passed to a router interface 308 for accessing and interfacing with routers on the network 316.

The software application 304 may identify a call origination as being on a client virtual private network (“VPN”) or may identify a router IP address passed to the router interface 306 as belonging to a client VPN. In such a case, the user interface 200 may provide a labeled section of the call path client VPN 202. Further, in some examples, routers along the call path on the client network may be identified and displayed within the user interface 200. In FIG. 2, the client VPN 202 includes two routers 206 and 208, as well as a client network 201. The client network 201 can be a Local Area Network (“LAN”) or other personal network and may include one or more client routers 205. The router 208 can provide an exit point within the client network 202 for voice communication session transmissions by peering with a voice device 216. Routers 206 and 208 may transmit information to each other over a multiprotocol label switching (“MPLS”) network 204 such that the software application 302 can identify the network portion via the router interface 308.

In some examples, routers can be identified as connected to particular voice devices. The voice device may be on the same network or on an altogether different network and may be indicated as so by the interface 200.

For example, as depicted in FIG. 2, router 208 may be paired with voice device 216. Router 208 is a component of the client network 202 and peers with voice device 216, which is a component of a voice network 214. Here, the voice device 216 has been observed to be faulty, as can be seen from the linkage between the client router 208 and the voice device 216 with the voice device 216 including no subsequent downstream linkage (e.g., to a router 218 or the like). The software application 308 can detect the fault by identifying a voice device with a received voice communication session data but no matching outbound voice communication session data. In some examples, workflows, alerts, and the like may be triggered based on detection of the faulty device. For example, a respective icon in a generated interface may be graphically marked to enable streamlined identification of faulty devices along a call path.

The interface 200 can display a call trace path to an alternate router 212 (e.g., a forked path) which may receive the transmission via a third party MPLS network 210. While the single alternate router 212 is discussed here, it is understood that multiple other routers may carry a call through one or more other networks before it enters or reenters the voice network 214.

The router 212 may then process the voice communication session transmission on linked voice device 217. In comparison to voice device 216, voice device 217 forwards the voice communication session transmission to a router 218 on the voice network 214. In sequence, the router 218 can forward the voice communication session transmission through a MPLS network 220 and on to another router 222 with an associated voice device 224 of voice network 214.

The voice device 224 of voice network 214 may further transmit the voice communication session transmission into yet another network, such as dedicated Internet access (DIA), virtual private network (VPN), public switched telephone network (PSTN) 226, and the like. As with the preceding networks, the DIA/VPN/PSTN network 226 may include a router 228 transmitting the call to a router 232 over a MPLS network 230. In some examples, the DIA/VPN/PSTN network 226 may be rendered by the interface 200 as a generic “other” network. In other examples, a particular type of network may be indicated, such as a public switched telephone network (“PSTN”) network, a VPN network, an ISP network, and the like.

In some instances, the interface 200 may group related components into respective network identifiers. For example, the client VPN 202 may be rendered (by the interface rendered 312) to include the client network 201, routers 205, 206, and 208, and MPLS network 204. In some examples, different network types may include different interface functionality that may be linked to availability of information from the targeted network for ease of technician review or a result of an applied filter, and the like.

The DIA/VPN/PSTN network 226 may further transmit the voice communication session transmission into a network labeled as “other ISP” 234 via an entry point router 236 or labeled as some other network identifier. In some cases, this may be the extent of the transmission path sought. For example, a terminal endpoint of the voice communication transmission may continue through one or more other networks; however, a technician seeking to troubleshoot only a limited leg of the transmission path (e.g., a portion that travels along the technician network) such that the rendered path may terminate at a particular component or network along the call path.

The user interface 200 can include additional functionality, such as indicating an IP address for each router (not depicted) or color-coding router operational health (not depicted). In some examples, route path segments may include a color coding as well to indicate, for example and without limitation, speed of data over the path segment or quality of transmission and the like.

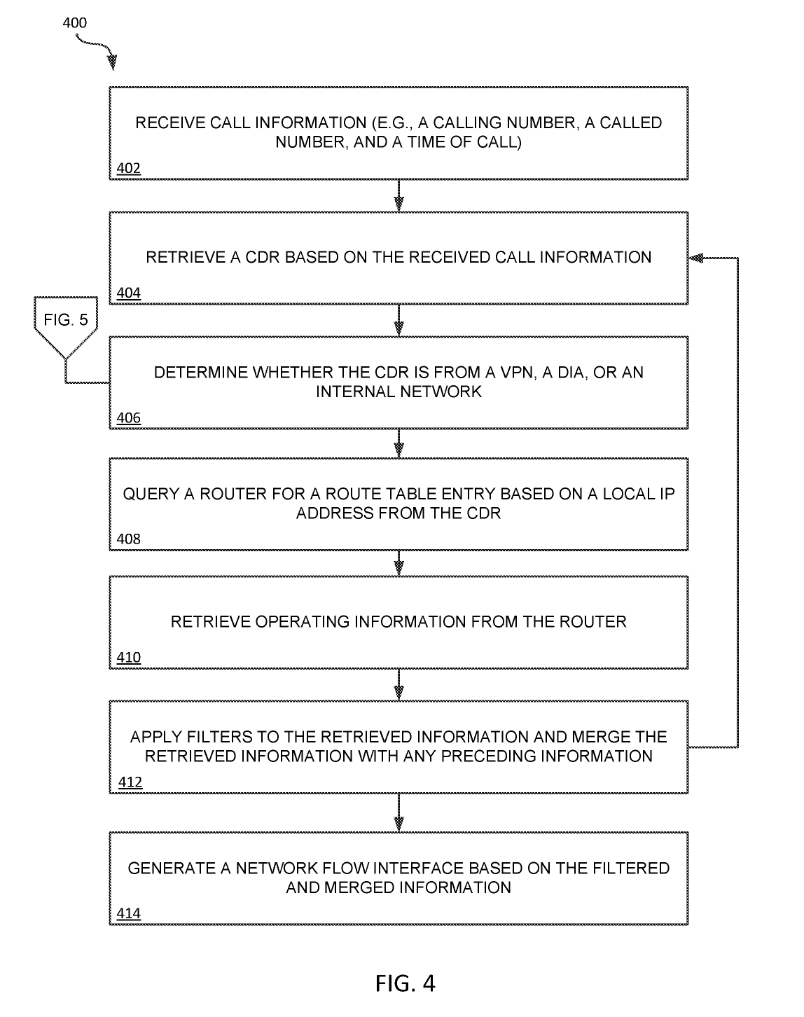

FIG. 4 depicts a method 400 by which the information utilized to render the interface 200 may be acquired from components associated with a call path through one or more networks. The server 116 or computing device 118 may include software, modules, and other components for querying routers and/or retrieving a CDR from voice equipment. In some examples, multiple interacting software services or micro-services may perform the method 400.

Call information such as a calling number, a called number, and a call time may be received through, for example, an input interface (operation 402). The input interface may include fields for the calling number, called number, and/or call time. In some examples, a technician may input the call information into the fields of the input interface to generate receiving the call information. In other examples, the call information can automatically be entered when a voice communication session is initiated or when certain triggering criteria are met.

The received call information may be used to retrieve a CDR (operation 404). The CDR can be retrieved directly from voice equipment which initiated a voice communication session, from voice equipment utilized in the call path, or from voice equipment associated with the call path. In one example, the initiating voice equipment may be indicated by the call information and can be retrieved by the server 106.

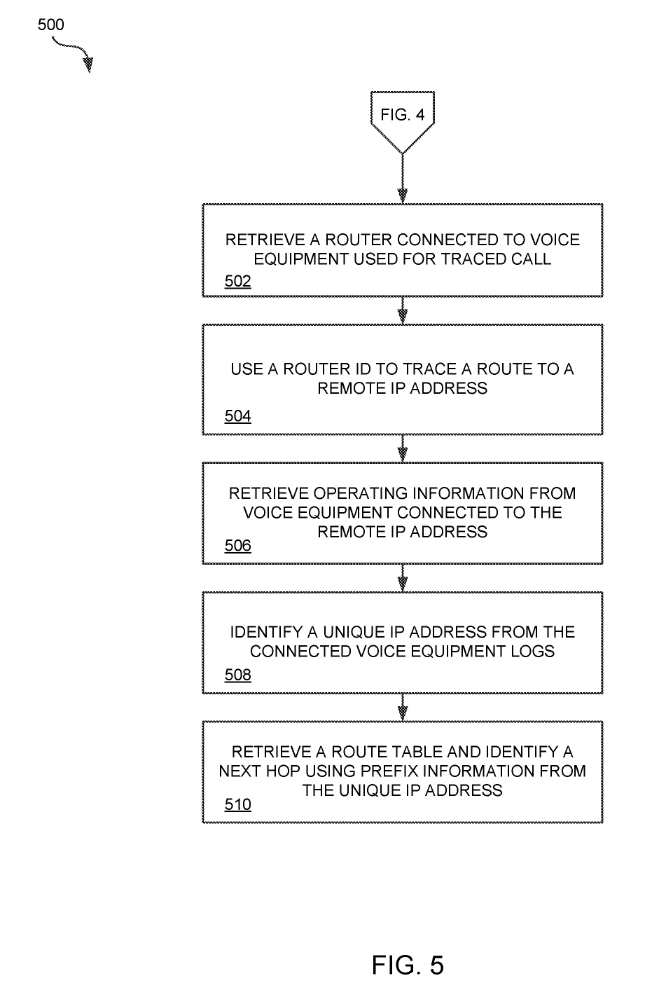

The CDR can then be processed to determine whether it is associated with a VPN, DIA, or an internal network (operation 406). In some examples, a CDR from a VPN can be further processed, as depicted by FIG. 5, by a method 500. The internal path of the voice communication session within the VPN may first be mapped before the session exits into, for example, a communications network or the like.

The voice equipment used to perform the voice communication session may be identified by the CDR and used to retrieve an associated router (operation 502). The CDR or the voice equipment can include an outbound route which may include a network router through which the voice communication session propagates. In some examples, this may be a unique router identification or an IP address.

Nevertheless, the router identification may then be used to trace a route to a remote IP address (operation 504). For example, the server 116 may query the indicated router for an exit point from the network and an entry point into the next network. In some examples, the remote IP address may be associated with voice equipment or the like.

In some examples, operating information may then be retrieved from voice equipment connected to the remote IP address (operation 506). The operating information can include various diagnostic information such as response times, failure rates, and the like. Further, a CDR can be included in the operating information and may include details of voice communications transmissions inbound to the voice equipment, as well as an outbound path.

Logs stored by the connected voice equipment can be used to identify a unique, or non-duplicate, destination IP address for a call (operation 508). The logs may be a part of the CDR or may be in addition to the CDR and may be provided to the requesting device for determining the call path through the corresponding network.

A route table associated with the unique IP address may be used to identify a next hop based on prefix information included in the unique IP address (operation 510). The route table may define the next hop based on the destination address associated with the voice communications transmission being traced. Based on the destination address, a particular next hop can be defined, for example, in the control plane of a network in which the router is located and the definition may be stored within the route table.

Returning to FIG. 4, a local IP address identified by the CDR can be used to query a router for a route table entry (operation 408). Similarly to steps within method 500 discussed above, the route table can be used to determine the next hops across each router in a network. The CDR may be used to provide a destination address for querying the router.

Operating information may further be retrieved from the router (operation 410). In addition, operating information such as connectivity and speed data can be obtained from the router. Furthermore, where the queried router is associated with voice equipment, the associated voice equipment may provide another CDR and the process may repeat itself. A sequence of identifying a router and/or associated voice equipment, obtaining operating information, and obtaining a next position along the voice communication session path through the network may be repeated as needed in order to fully map out a path through the network. In some examples, a large number of routers and associated voice equipment may undergo method 400 until a complete path is mapped. In other examples, only specific network segments, such as LVLT, may be mapped in this way.

Having retrieved router operating information, selected filters can be applied to the retrieved information and the retrieved information can be merged with any previously retrieved information (e.g., retrieved from preceding hops along the voice communication transmission path) (operation 412). Filters may include parent networks, speed, whether an associated voice equipment succeeded in propagating the voice communication transmission, and others as will be understood by a person having ordinary skill in the art. For example, a parent network filter may be selected to display only information related to call paths originating from a particular network in order to identify pathing issues associated with a particular edge network or the like.

The collected information can then be used to generate a network flow interface based on the filtered and merged information (operation 414). For example, the network flow interface may be rendered as depicted in FIG. 2. The network flow interface may further include various control functions such as routing a voice communication session into or around particular voice equipment and/or routers. For example, as depicted in FIG. 2, where voice equipment 216 is detected as faulty, an administrator or the like may reroute the call path through router 212 and to voice equipment 217 via the network flow interface.

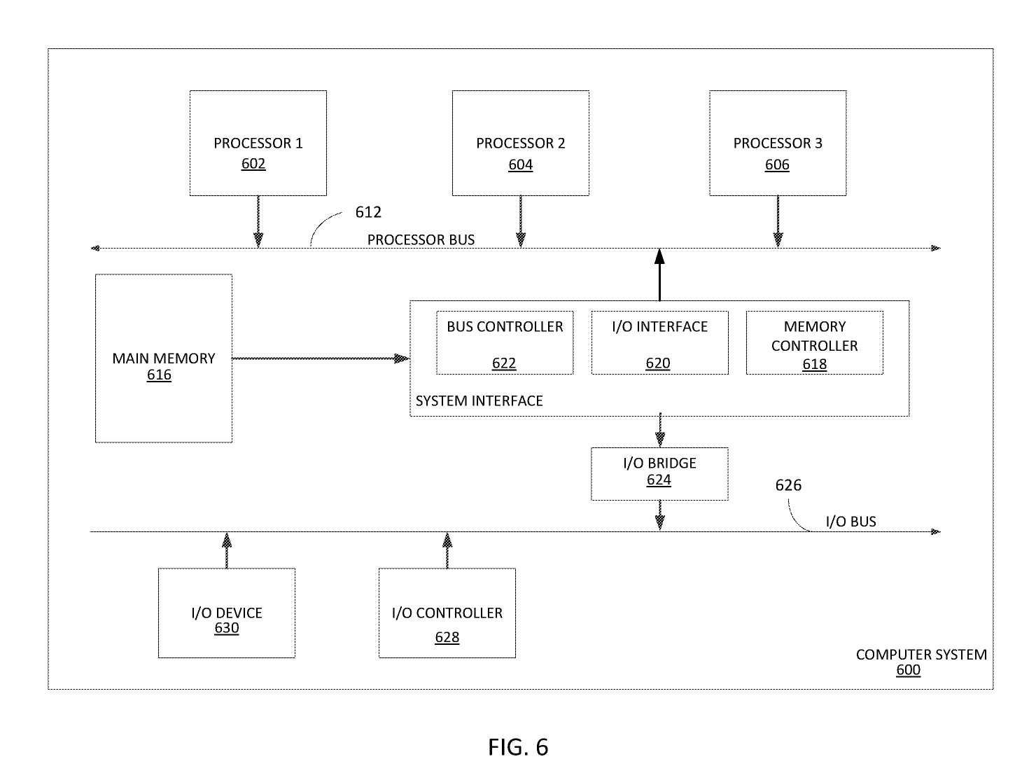

FIG. 6 is a block diagram illustrating an example of a computing device or computer system 600 which may be used in implementing the embodiments of the components of the network disclosed above. For example, the computing system 600 of FIG. 6 may perform method 400 and/or method 500 discussed above. The computer system (system) includes one or more processors 602-606. Processors 602-606 may include one or more internal levels of cache (not shown) and a bus controller or bus interface unit to direct interaction with the processor bus 612. Processor bus 612, also known as the host bus or the front side bus, may be used to couple the processors 602-606 with the system interface 614. System interface 614 may be connected to the processor bus 612 to interface other components of the system 600 with the processor bus 612. For example, system interface 614 may include a memory controller 614 for interfacing a main memory 616 with the processor bus 612. The main memory 616 typically includes one or more memory cards and a control circuit (not shown). System interface 614 may also include an input/output (I/O) interface 620 to interface one or more I/O bridges or I/O devices with the processor bus 612. One or more I/O controllers and/or I/O devices may be connected with the I/O bus 626, such as I/O controller 628 and I/O device 640, as illustrated.

I/O device 640 may also include an input device (not shown), such as an alphanumeric input device, including alphanumeric and other keys for communicating information and/or command selections to the processors 602-606. Another type of user input device includes cursor control, such as a mouse, a trackball, or cursor direction keys for communicating direction information and command selections to the processors 602-606 and for controlling cursor movement on the display device.

System 600 may include a dynamic storage device, referred to as main memory 616, or a random access memory (RAM) or other computer-readable devices coupled to the processor bus 612 for storing information and instructions to be executed by the processors 602-606. Main memory 616 also may be used for storing temporary variables or other intermediate information during execution of instructions by the processors 602-606. System 600 may include a read only memory (ROM) and/or other static storage device coupled to the processor bus 612 for storing static information and instructions for the processors 602-606. The system set forth in FIG. 6 is but one possible example of a computer system that may employ or be configured in accordance with aspects of the present disclosure.

According to one embodiment, the above techniques may be performed by computer system 600 in response to processor 604 executing one or more sequences of one or more instructions contained in main memory 616. These instructions may be read into main memory 616 from another machine-readable medium, such as a storage device. Execution of the sequences of instructions contained in main memory 616 may cause processors 602-606 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 616. Common forms of machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

Embodiments of the present disclosure include various steps, which are described in this specification. The steps may be performed by hardware components or may be embodied in machine-executable instructions, which may be used to cause a general-purpose or special purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

We claim:

1. A method for tracing a path of a voice communication transmission over a network, the method comprising:
obtaining, from a first voice equipment and at a computing device, a first call detail record (“CDR”) comprising information associated with a transmission of a voice communication to a network from the first voice equipment, the information indicating a first router of the transmission;
requesting voice equipment operating information from the first voice equipment, the voice equipment operating information including outbound transmissions, and first router operating information from the first router;
generating an interface comprising the first voice equipment operating information and the first router operating information;
receiving an input through the interface for a call path alteration, the call path alteration rerouting voice communications to an alternate router; and
rerouting transmissions away from the first router and to the alternate router according to the received input.

2. The method of claim 1, further comprising:
receiving a next hop information from the first router; and
receiving second router operating information from a second router based on the next hop information from the first router;
wherein the interface further comprises the next hop information and the second router operating information.

3. The method of claim 2, wherein the second router is associated with a second voice equipment, the method further comprising:
receiving, from the second voice equipment a second CDR and a second voice equipment operating information;
wherein the interface further comprises the second voice equipment operating information.

4. The method of claim 2, further comprising receiving multiple router information from respective multiple routers, the multiple routers comprising hops between the first router and the second router within the network, wherein the interface further comprises the multiple router information.

5. The method of claim 4, wherein the network comprises one or more of a client network, an Internet service provider (“ISP”) network, or a voice network.

6. The method of claim 1, wherein the first voice equipment is identified based on a database comprising call information associated with voice equipment identifiers.

7. The method of claim 1, further comprising receiving a filter selection for one of particular information or particular devices, wherein the interface comprises information based on the received filter selection.

8. A system for tracing a path of a voice communication transmission over a network, the system comprising:
one or more processors; and
a memory comprising instructions to:
obtain, from a first voice equipment and at a computing device, a first call detail record (“CDR”) comprising information associated with a transmission of a voice communication to a network from the first voice equipment, the information indicating a first router of the transmission;
request voice equipment operating information from the first voice equipment, the voice equipment operating information including outbound transmissions, and first router operating information from the first router;
generate an interface comprising the first voice equipment operating information and the first router operating information;
receive an input through the interface for a call path alteration, the call path alteration rerouting voice communications to an alternate router; and
reroute transmissions away from the first router and to the alternate router according to the received input.

9. The system of claim 8, wherein the memory further comprises instructions to:
receive a next hop information from the first router; and
receive second router operating information from a second router based on the next hop information from the first router;
wherein the interface further comprises the next hop information and the second router operating information.

10. The system of claim 9, wherein the second router is associated with a second voice equipment, and the memory further comprises instructions to:
receive, from the second voice equipment a second CDR and a second voice equipment operating information;
wherein the interface further comprises the second voice equipment operating information.

11. The system of claim 9, wherein the memory further comprises instructions to receive multiple router information from respective multiple routers, the multiple routers comprising hops between the first router and the second router within the network, wherein the interface further comprises the multiple router information.

12. The system of claim 11, wherein the network comprises one or more of a client network, an Internet service provider (“ISP”) network, or a voice network.

13. The system of claim 8, further comprising a database comprising call information associated with voice equipment identifiers, wherein the first voice equipment is identified based on the database.

14. The system of claim 8, wherein the memory further comprises instructions to receive a filter selection for one of particular information or particular devices, wherein the interface comprises information based on the received filter selection.

15. A non-transitory computer readable medium storing instructions that, when executed by one or more processors, causes the one or more processors to:
obtain, from a first voice equipment and at a computing device, a first call detail record (“CDR”) comprising information associated with a transmission of a voice communication to a network from the first voice equipment, the information indicating a first router of the transmission;
request voice equipment operating information from the first voice equipment, the voice equipment operating information including outbound transmissions, and first router operating information from the first router;
generate an interface comprising the first voice equipment operating information and the first router operating information;
receive an input through the interface for a call path alteration, the call path alteration rerouting voice communications to an alternate router; and
reroute transmissions away from the first router and to the alternate router according to the received input.

16. The non-transitory computer readable medium of claim 15, further storing instructions to:
receive a next hop information from the first router; and
receive second router operating information from a second router based on the next hop information from the first router;
wherein the interface further comprises the next hop information and the second router operating information.

17. The non-transitory computer readable medium of claim 16, wherein the second router is associated with a second voice equipment, and further storing instructions to:
receive, from the second voice equipment a second CDR and a second voice equipment operating information;
wherein the interface further comprises the second voice equipment operating information.

18. The non-transitory computer readable medium of claim 16, further storing instructions to receive multiple router information from respective multiple routers, the multiple routers comprising hops between the first router and the second router within the network, wherein the interface further comprises the multiple router information.

19. The non-transitory computer readable medium of claim 15, wherein the first voice equipment is identified based on a database comprising call information associated with voice equipment identifiers.

20. The non-transitory computer readable medium of claim 15, further storing instructions to receive a filter selection for one of particular information or particular devices, wherein the interface comprises information based on the received filter selection.
